(19) United States
(12) Patent Application Publication
(10) Pub. No.: US 2025/0172846 A1
(43) Pub. Date: May 29, 2025

(54) DISPLAY ASSEMBLY WITH INCREASED DUTY CYCLE AND REDUCED POWER CONSUMPTION

(71) Applicant: Meta Platforms Technologies, LLC, Menlo Park, CA (US)

(72) Inventors: Shin Ying LU, Bellevue, WA (US); Yuge HUANG, Painted Post, NY (US); Hsien-Hui CHENG, Woodinville, WA (US); Fenglin PENG, Redmond, WA (US)

(21) Appl. No.: 18/935,632

(22) Filed: Nov. 3, 2024

Related U.S. Application Data
(60) Provisional application No. 63/603,557, filed on Nov. 28, 2023.

(51) Int. Cl. G02F 1/141; G02F 1/1335; G02F 1/13357; G02F 1/13363; G02F 1/1343

(52) U.S. Cl. CPC G02F 1/141; G02F 1/13355; G02F 1/133609; G02F 1/133638; G02F 1/134363

(57) ABSTRACT

A display assembly is provided. The display assembly includes a polarizing optical component configured to reflect a light having a first polarization and transmit a light having a second polarization orthogonal to the first polarization. The display assembly also includes a ferroelectric liquid crystal (“FLC”) display panel configured with a display frame that includes a normal sub-frame and a compensation sub-frame. The display assembly also includes a polarization switch disposed between the FLC display panel and the polarizing optical component. The display assembly further includes a controller configured to control the polarization switch to operate at a non-switching state during the normal sub-frame and operate at a switching state during the compensation sub-frame.

### CROSS REFERENCE TO RELATED APPLICATION

This application claims the benefit of priority to U.S. Provisional Application No. 63/603,557, filed on Nov. 28, 2023. The content of the above-referenced application is incorporated by reference in its entirety.

### TECHNICAL FIELD

The present disclosure relates generally to optical systems and, more specifically, to a display assembly with increased duty cycle and reduced power consumption.

### BACKGROUND

Display technologies have been widely used in a large variety of applications, such as smartphones, tablets, laptops, monitors, TVs, projectors, vehicles, virtual reality (“VR”) devices, augmented reality (“AR”) devices, mixed reality (“MR”) devices, etc. Non-emissive displays, such as liquid crystal displays (“LCDs”), liquid-crystal-on-silicon (“LCoS”) displays, or digital light processing (“DLP”) displays, may require a backlight unit to illuminate a display panel. Self-emissive displays may display images through emitting lights with different intensities and colors from light-emitting elements. A self-emissive display may also function as a locally dimmable backlight unit for a non-emissive display panel. A compact display engine with dynamic zonal brightness control with improved display performance and power budget is highly desirable, which can be incorporated into a variety of devices, and is suitable for portable devices including hand-held, wrist-worn, or head-mounted devices, etc.

### SUMMARY OF THE DISCLOSURE

One aspect of the present disclosure provides a display assembly. The display assembly includes a polarizing optical component configured to reflect a light having a first polarization and transmit a light having a second polarization orthogonal to the first polarization. The display assembly also includes a ferroelectric liquid crystal (“FLC”) display panel configured with a display frame that includes a normal sub-frame and a compensation sub-frame. The display assembly also includes a polarization switch disposed between the FLC display panel and the polarizing optical component. The display assembly further includes a controller configured to control the polarization switch to operate at a non-switching state during the normal sub-frame and operate at a switching state during the compensation sub-frame.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1 illustrates a schematic diagram of a ferroelectric liquid crystal (“FLC”) display assembly, according to an example of the present disclosure;

FIGS. 2A and 2B illustrate operations of an FLC display assembly, according to one or more examples of the present disclosure;

FIG. 3A shows a relationship between a display brightness and a driving scheme of an FLC display assembly, according to an example of the present disclosure;

FIG. 3B shows a relationship between a display brightness and a driving scheme of an FLC display assembly, according to an example of the present disclosure;

FIG. 4A shows a relationship between a display brightness and a driving scheme of an FLC display assembly, according to an example of the present disclosure;

FIG. 4B shows a relationship between a display brightness and a driving scheme of an FLC display assembly, according to an example of the present disclosure;

FIG. 5A illustrates a schematic diagram of an artificial reality system, according to an example of the present disclosure; and

FIG. 5B illustrates a schematic cross-sectional view of the artificial reality system shown in FIG. 5A, according to an example of the present disclosure.

### DETAILED DESCRIPTION

Various aspects of the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or a combination thereof. An “optical coupling” between two optical devices refers to a configuration in which the two optical devices are arranged in an optical series, and a light output from one optical device may be directly or indirectly received by the other optical device. An optical series refers to optical positioning of a plurality of optical devices in a light path, such that a light output from one optical device may be transmitted, reflected, diffracted, converted, modified, or otherwise processed or manipulated by one or more of other optical devices. The sequence in which the plurality of optical devices are arranged may or may not affect an overall output of the plurality of optical devices. A coupling may be a direct coupling or an indirect coupling (e.g., coupling through an intermediate element).

The phrase “one or more” may be interpreted as “at least one.” The phrase “at least one of A or B” may encompass various combinations of A and B, such as A only, B only, or A and B. Likewise, the phrase “at least one of A, B, or C” may encompass various combinations of A, B, and C, such as A only, B only, C only, A and B, A and C, B and C, or A and B and C. The phrase “A and/or B” has a meaning similar to that of the phrase “at least one of A or B.” For example, the phrase “A and/or B” may encompass various combinations of A and B, such as A only, B only, or A and B. Likewise, the phrase “A, B, and/or C” has a meaning similar to that of the phrase “at least one of A, B, or C.” For example, the phrase “A, B, and/or C” may encompass various combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The wavelength ranges, spectra, or bands mentioned in the present disclosure are for illustrative purposes. The disclosed optical device, system, element, assembly, and method may be applied to a visible wavelength range, as well as other wavelength ranges, such as an ultraviolet (“UV”) wavelength range, an infrared (“IR”) wavelength range, or a combination thereof.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The phrases “in-plane direction,” “in-plane orientation,” “in-plane rotation,” “in-plane alignment pattern,” and “in-plane pitch” refer to a direction, an orientation, a rotation, an alignment pattern, and a pitch in a plane of a film or a layer (e.g., a surface plane of the film or layer, or a plane parallel to the surface plane of the film or layer), respectively. The term “out-of-plane direction” or “out-of-plane orientation” indicates a direction or an orientation that is non-parallel to the plane of the film or layer (e.g., perpendicular to the surface plane of the film or layer, e.g., perpendicular to a plane parallel to the surface plane). For example, when an “in-plane” direction or orientation refers to a direction or an orientation within a surface plane, an “out-of-plane” direction or orientation may refer to a thickness direction or orientation perpendicular to the surface plane, or a direction or orientation that is not parallel with the surface plane.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

A conventional FLC display assembly may include a backlight module, a reflective ferroelectric liquid crystal on silicon (“FLCoS”) display panel, and a polarization beam splitter. The FLCoS display panel may include a ferroelectric liquid crystal (“FLC”) cell, where FLC molecules may be aligned in an alignment direction at a rest state (or a voltage-off state). The backlight module may output a first light (e.g., a backlight) toward the polarization beam splitter, which may polarize and reflect the first light as a second light propagating toward the FLCoS display panel. The FLCoS display panel may modulate and reflect the second light as a third light (e.g., an image light) back to the polarization beam splitter. The polarization beam splitter may transmit or block the third light depending on the polarization of the third light.

A display frame of the conventional FLC display assembly may include a first sub-frame (such as a normal sub-frame) and a second sub-frame (such as a charge balance sub-frame or a compensation sub-frame). The purpose of the charge balance sub-frame or compensation sub-frame is to reduce the image sticking in the conventional FLC display assembly. During the display frame of the conventional FLC display assembly, FLCs in the FLC cell may be in-plane switched via switching the polarity of an electric field E applied to the FLC cell. For example, during the first sub-frame (e.g., the normal sub-frame), an external positive electric field +E may be applied across the FLC cell, and the FLC molecules may be reoriented to a first side away from the alignment direction. The second light output from the polarization beam splitter may be a linearly polarized light having a 0° polarization direction. The FLCoS display panel may modulate the second light as the third light, which may be a linearly polarized light having a 90° polarization direction. The polarization beam splitter may substantially transmit the third light having the 90° polarization direction. Accordingly, the conventional FLC display assembly may generate a normal image, e.g., a white image (e.g., a 255-greyscale image).

During the second sub-frame (e.g., the charge balance sub-frame), a negative external electric field −E may be applied across the FLC cell, and the FLC molecules may be flipped to a second, opposing side away from the alignment direction. The FLCoS display panel may modulate the second light as the third light, which may be a linearly polarized light having a 0° polarization direction. The polarization beam splitter may substantially block the third light having the 0° polarization direction from being transmitted. Accordingly, the conventional FLC display assembly may generate a dark image (e.g., a 0-greyscale image). The dark image (e.g., 0-greyscale image) displayed during the second sub-frame (or compensation sub-frame) may be an inverted image of the white image (e.g., 255-greyscale image) displayed during the first sub-frame (e.g., the normal sub-frame).

During the entire display frame, a user may perceive an image that is a combination of the normal image displayed during the first sub-frame (e.g., the normal sub-frame) and the inverse image displayed during the second sub-frame (e.g., the compensation sub-frame). The inverse image, if not eliminated, may degrade the quality of an image perceived by a user during the entire display frame. Thus, in the practical application of the conventional FLC display assembly, the backlight source (e.g., a light emitting diode (“LED”) light source) needs to be turned off during the second sub-frame (e.g., the charge balance sub-frame) to suppress the inverse image (e.g., 0-greyscale image). In some applications, a light shutter or light switch may be disposed between the backlight source and the FLCoS display panel. The backlight source (e.g., LED light source) may not be turned off during the second sub-frame (e.g., the charge balance sub-frame), and the light shutter or switch may block the backlight from being incident onto the FLCoS display panel. Furthermore, due to the existence of the charge balance sub-frame in the conventional FLC display assembly, the conventional FLC display assembly may only utilize a 50% duty cycle of the backlight source for displaying a white, 255-grayscale image. The duty cycle of the backlight source may be defined as a ratio of a time period during which the backlight source is turned on (referred to as on-time) over the entire display frame.

To compensate for the 50% duty cycle of the conventional FLC display assembly and to allow the user to perceive an image with a substantially same brightness as an image displayed by a conventional nematic LC display assembly having a 100% duty cycle, the LED brightness during the normal sub-frame of the conventional FLC display assembly may need to be doubled, requiring a higher LED current density. However, the increase in the LED current density may cause a reduction in the wall-plug efficiency, resulting in a higher power consumption for the conventional FLC display assembly.

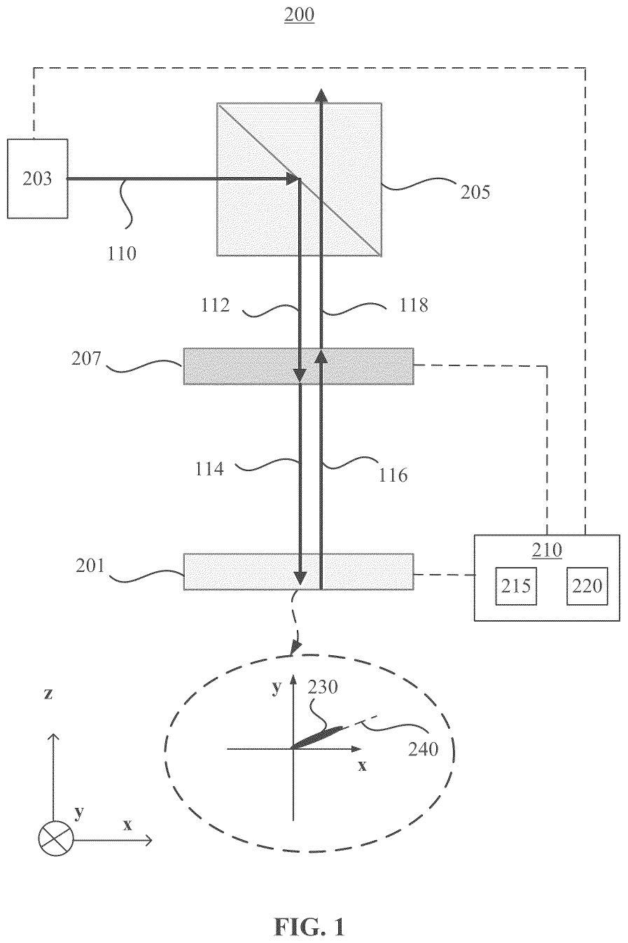

In view of the limitations of the conventional technologies, the present disclosure provides a ferroelectric liquid crystal display assembly with increased duty cycle and reduced power consumption. FIG. 1 illustrates an x-z sectional view of a ferroelectric liquid crystal (“FLC”) display assembly 200, according to an example of the present disclosure. As shown in FIG. 1, the FLC display assembly 200 may include a backlight source (or module) 203, a polarizing optical component 205, a polarization switch 207, an FLC display panel 201, and a controller 210. The backlight source 203 may be disposed at a first side of the polarizing optical component 205, and the polarization switch 207 and the FLC display panel 201 may be disposed at a second side of the polarizing optical component 205, where the second side may be different from the first side. The polarization switch 207 may be disposed between the FLC display panel 201 and the polarizing optical component 205. In FIG. 1, the FLC display panel 201, the polarization switch 207, and the polarizing optical component 205 are shown as being spaced apart from one another by a gap. In some examples, the FLC display panel 201, the polarization switch 207, and the polarizing optical component 205 may be stacked without a gap (e.g., through direct contact).

In some examples, the controller 210 may be communicatively coupled with the backlight source 203, the polarization switch 207, and the FLC display panel 201 to control the respective operations. In some examples, the backlight source 203, the polarization switch 207, and the FLC display panel 201 may be communicatively coupled with different controllers. The controller 210 may include a processor or processing unit 220. The processor 220 may be any suitable processor, such as a central processing unit (“CPU”), a graphic processing unit (“GPU”), etc., which may include both hardware and software components. The controller 210 may include a storage device 215. The storage device 215 may be a non-transitory computer-readable medium, such as a memory, a hard disk, etc. The storage device 215 may be configured to store data or information, including computer-executable program instructions or codes, which may be executed by the processor 220 to perform various controls or functions described in the methods or processes disclosed herein.

The polarizing optical component 205 may be configured to substantially block an input light having a first polarization, and substantially transmit an input light having a second polarization that is orthogonal to the first polarization. In some examples, the polarizing optical component 205 may be configured to substantially block, via reflection or absorption, the light having the first polarization. The polarizing optical component 205 may function as crossed polarizers. For example, the polarizing optical component 205 may include one or more polarization beam splitters, one or more reflective polarizers, or one or more absorptive polarizers, etc. For discussion purposes, in the following description, the polarizing optical component 205 is shown as a polarization beam splitter (also referred to as 205).

The polarization switch 207 may be configured to be switchable between operating at a switching state and operating at a non-switching state. In some examples, the controller 210 may control the polarization switch 207 to switch between operating at the switching state and operating at the non-switching state. The polarization switch 207 operating at the switching state may change the polarization of an input light, while transmitting the input light toward the FLC display panel 201. The polarization switch 207 operating at the non-switching state may maintain the polarization of the input light while transmitting the input light toward the FLC display panel 201.

In some examples, the polarization switch 207 may include a switchable half-wave plate. In some examples, the switchable half-wave plate may be electrically driven. For example, the switchable half-wave plate may be electrically coupled with a power source (not shown), and the controller 210 may be communicatively coupled with the power source to control an output of the power source. In some examples, the switchable half-wave plate may be a suitable liquid crystal (“LC”)-based switchable half-wave plate that includes one or more LC cells, e.g., a Pi cell, a ferroelectric cell, an electronically controlled birefringence (“ECB”) cell, a dual ECB cell, or a combination thereof. In some examples, the switchable half-wave plate may include in-plane switchable FLCs. When the switchable half-wave plate operates at the non-switching state, the LC directors may be aligned in parallel with, or perpendicular to, the polarization direction of a linearly polarized input light. The FLCs may be configured to have a switching angle of 22.5° or 67.5° (when defined with respect to the alignment direction). In some examples, the switchable half-wave plate may include nematic FLCs with antiparallel alignments with top-down electrodes (also known as ECB cell). In some examples, the polarization switch 207 may include a twisted-nematic liquid crystal (“TNLC”) cell. For discussion purposes, in the following description, the polarization switch 207 is shown as a switchable half-wave plate (also referred to as 207).

The FLC display panel 201 may be a suitable reflective FLC display panel 201, including, but not limited to, a reflective FLCoS display panel. In some examples, the controller 210 may control the FLC display panel 201 to switch between operating during a normal sub-frame and operating during a compensation sub-frame. The controller 210 may control the switching of the polarization switch 207 (between the non-switching state and the switching state) to be synchronized with the switching of the FLC display panel 201 (between the normal sub-frame and the compensation sub-frame). In some examples, the switching speed of the polarization switch 207 may be comparable to the switching speed of the FLC display panel 201, e.g., equal to or higher than the switching speed of the FLC display panel 201.

As shown in FIG. 1, the backlight source 203 may output a light 110 (e.g., a backlight) propagating toward the polarization beam splitter 205. The light 110 may be an unpolarized light or a partially polarized light. The polarization beam splitter 205 may block a light having a first polarization via reflection, and transmit a light having a second polarization. For discussion purposes, FIG. 1 shows that the light 110 is a polarized light having the first polarization. Thus, the polarization beam splitter 205 may block the light 110 via reflection, reflecting the light 110 as a light 112 propagating toward the polarization switch 207.

The light 112 may also be a polarized light having the first polarization. The polarization switch 207 may transmit the light 112 as a light 114 propagating toward the FLC display panel 201. The polarization switch 207 operating at the non-switching state may maintain the polarization of the light 112. The polarization switch 207 operating at the switching state may change the polarization of the light 112, while transmitting the light 112 toward the FLC display panel 201.

The FLC display panel 201 may include an FLC cell, where FLC molecules 230 may be aligned in an alignment direction 240 (e.g., within the x-y plane) at a rest state (or a voltage-off state). The FLC display panel 201 operating at a voltage-on state may modulate and reflect the light 114 as a light 116 (that is an image light) back to the polarization switch 207. The FLC display panel 201 operating at the voltage-on state may be configured to provide a wave retardance to the light 114, while reflecting the light 114 back to the polarization switch 207. The FLC display panel 201 operating during the normal sub-frame and compensation sub-frame may provide different wave retardances to the light 114, while reflecting the light 114 back to the polarization switch 207. The polarization switch 207 may transmit the light 116 as a light 118 propagating toward the polarization beam splitter 205. The polarization switch 207 operating at the non-switching state may maintain the polarization of the light 116. The polarization switch 207 operating at the switching state may change the polarization of the light 116. The polarization beam splitter 205 may substantially transmit or block the light 118 depending on the polarization of the light 118.

For discussion purposes, in the example shown in FIG. 1, the first polarization may be a linear polarization polarized in a first direction, and the second polarization may be a linear polarization polarized in a second direction orthogonal to the first direction. The polarization beam splitter 205 may substantially reflect a linearly polarized light polarized in the first direction, and substantially transmit a linearly polarized light polarized in the second direction. The alignment direction 240 may be configured as a third direction that forms a first predetermined angle μ (e.g., about 67.5°) with respect to the first direction.

A display frame of the FLC display panel 201 may include a first sub-frame (e.g., a normal sub-frame) and a second sub-frame (e.g., a charge balance sub-frame or a compensation sub-frame). The FLCs or FLC molecules 230 in the FLC display panel 201 may be in-plane switched between two reorientation states (or two different switching angles) via switching the polarity of an electric field E applied to the FLC cell. To produce color and grey-scale, time multiplexing may be used (e.g., via controlling the backlight source or module 203 by the controller 210), exploiting the sub-millisecond switching time of the FLCs.

When the FLCs are in-plane switched to a first reorientation state, an optic axis (e.g., a slow axis) of the FLC display panel 201 may be oriented in a fourth direction that forms a second predetermined angle α (e.g., about 45°) with respect to the first direction. The FLC display panel 201 may be configured to provide a quarter-wave retardance to the light 114 propagating therethrough. The FLC display panel 201 may reflect the light 114 as the light 116 back to the switchable half-wave plate 207, and provide a quarter-wave retardance to the light 116 propagating therethrough. Thus, the FLC display panel 201 may function as a half-wave plate for the light 114 while reflecting the light 114 as the light 116. The polarization direction of the light 116 may be rotated by 90° with respect to the polarization direction of the light 114.

When the FLCs are in-plane switched to a second reorientation state, an optic axis (e.g., a slow axis) of the FLC display panel 201 may be oriented in a fifth direction that forms a third predetermined angle α′ (e.g., about 0°) with respect to the first direction. the FLC display panel 201 may provide a quarter-wave retardance to the light 114 propagating therethrough. The FLC display panel 201 may reflect the light 114 as the light 116 back to the switchable half-wave plate 207, and provide a quarter-wave retardance to the light 116 propagating therethrough. Thus, the FLC display panel 201 may function as a half-wave plate for the light 114 while reflecting the light 114 as the light 116. The polarization direction of the light 116 may be rotated by 90° with respect to the polarization direction of the light 114.

For discussion purposes, in the example shown in FIG. 1, the polarization switch 207 may include a switchable half-wave plate (also referred to as 207). An optic axis (e.g., slow axis) of the switchable half-wave plate 207 may be oriented in a sixth direction that forms a fourth predetermined angle β (e.g., about 22.5°) with respect to the first direction. Thus, the switchable half-wave plate 207 that operates at the switching state may rotate the polarization direction of the light 112 or 116 by an angle of 2*β, while transmitting the light 112 or 116. The switchable half-wave plate 207 that operates at the non-switching state may maintain the polarization direction of the light 112 or 116, while transmitting the light 112 or 116.

The controller 210 may control the switchable half-wave plate 207 to operate at the non-switching state during the normal sub-frame, and operate at the switching state during the compensation sub-frame. Through configuring the orientation of the optic axis (e.g., the slow axis) of the switchable half-wave plate 207, the light 118 output from the switchable half-wave plate 207 that operates at the switching state may be a polarized light that is polarized in the second direction. Thus, the polarization beam splitter 205 may substantially transmit the light 118 toward the user without affecting the propagation direction of the light 118. That is, the switchable half-wave plate 207 that operates at the switching stat may correct an inverse image generated during the compensation sub-frame of the FLC display panel 201.

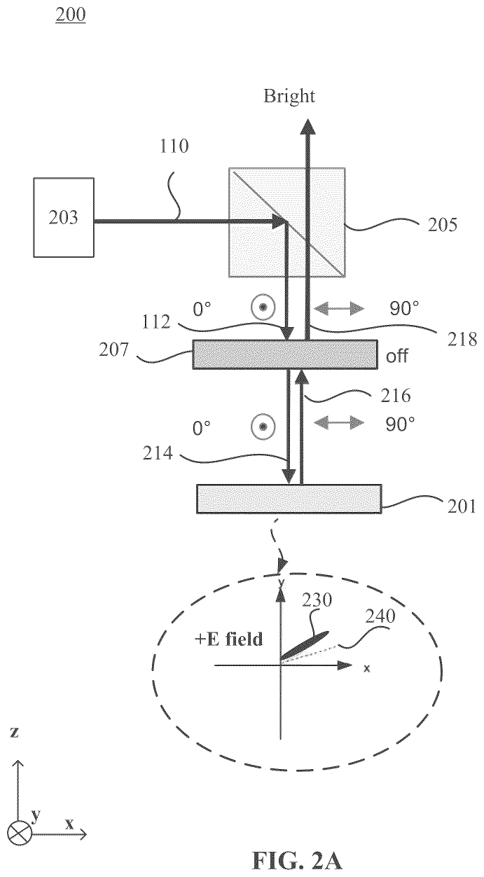

FIGS. 2A and 2B illustrate operations of the FLC display assembly 200 shown in FIG. 1, according to one or more examples of the present disclosure. For discussion purposes, in the following discussion of the FLC display assembly 200, the first direction may be in a y-axis direction shown in FIG. 1 and FIGS. 2A and 2B, and the first direction may also be referred to as a 0° polarization direction within the x-y plane. The first direction is a reference direction for the orientations of other optical elements in the FLC display assembly 200. The second direction may be a 90° polarization direction (e.g., an x-axis direction) within the x-y plane. The third direction may be a 67.5° polarization direction within the x-y plane. The fourth direction may be a 45° polarization direction within the x-y plane. The fifth direction may be a 0° polarization direction within the x-y plane. The sixth direction may be a 22.5° polarization direction within the x-y plane. The FLCs in the FLC display panel 201 may be configured to have a switching angle of 22.5° or 67.5° with respect to the alignment direction 240. For example, when the alignment direction 240 is the 67.5° polarization direction within the x-y plane and the switching angle of the FLCs in the FLC display panel 201 is 22.5°, the FLCs may be switched between being reoriented along the 45° polarization direction within the x-y plane (e.g., via the +E field) and being reoriented along the 90° polarization direction (the x-axis direction) within the x-y plane (e.g., via the −E field).

As shown in FIG. 2A, during the first sub-frame (e.g., the normal sub-frame), the controller (e.g., the controller 210 shown in FIG. 1) may control the electric field E such that the FLCs are in-plane switched to the first reorientation state, and control the switchable half-wave plate 207 to operate at the non-switching state. The FLC display panel 201 may be configured to display a bright image, which is presumed to be a normal image. The light 112 may be the linearly polarized light that may be polarized in the 0° polarization direction within the x-y plane. The switchable half-wave plate 207 that operates at the non-switching state may maintain the polarization direction of the light 112, while transmitting the light 112. Thus, the switchable half-wave plate 207 may output a light 214 that is a linearly polarized light polarized in the 0° polarization direction within the x-y plane.

The controller (e.g., the controller 210 shown in FIG. 1) may control an external electric field +E to apply across the FLC cell, and the FLC molecules 230 may be reoriented to a first side away from the alignment direction 240. For discussion purposes, FIG. 2A shows that the FLC molecules 230 are reoriented in the 45° polarization direction within the x-y plane via the external electric field +E. The FLC display panel 201 may modulate and reflect the light 214 as a light 216. The FLC display panel 201, in which the FLCs are in the first reorientation state, may provide a quarter-wave retardance to the light 214 propagating therethrough, and provide a quarter-wave retardance to the light 216 propagating therethrough. Thus, the light 216 output from the FLC display panel 201 may be a linearly polarized light that may be polarized in the 90° polarization direction within the x-y plane.

The switchable half-wave plate 207 that operates at the non-switching state may maintain the polarization direction of the light 216, while transmitting the light 216 toward the polarization beam splitter 205. Thus, the switchable half-wave plate 207 may output a light 218 that may be a linearly polarized light polarized in the 90° polarization direction within the x-y plane. The polarization beam splitter 205 may substantially transmit the light 218 without affecting the propagation direction of the light 218. Accordingly, the FLC display assembly 200 may display a bright image (denoted by “Bright” in FIG. 2A).

As shown in FIG. 2B, during the second sub-frame (e.g., the compensation sub-frame), the controller (e.g., the controller 210 shown in FIG. 1) may control the electric field E such that the FLCs may be in-plane switched to the second reorientation state, and control the switchable half-wave plate 207 to operate at the switching state. The FLC display panel 201 may also be configured to display the bright image, which is the normal image.

The light 112 may be a linearly polarized light polarized in the 0° polarization direction within the x-y plane. The switchable half-wave plate 207 that operates at the switching state may rotate the polarization direction of the light 112 by 45°, while transmitting the light 112. Thus, the switchable half-wave plate 207 may output a light 224 that may be a linearly polarized light polarized in the 45° polarization direction within the x-y plane. The controller (e.g., the controller 210 shown in FIG. 1) may control an external electric field −E to apply across the FLC cell, and the FLC molecules 230 may be reoriented to a second, opposing side away from the alignment direction 240.

For discussion purposes, FIG. 2B shows that the FLC molecules 230 are reoriented in the 90° polarization direction (x-axis) within the x-y plane via the external electric field −E. The FLC display panel 201 may modulate and reflect the light 224 as a light 226 back to the switchable half-wave plate 207. The FLC display panel 201, in which the FLCs are in the second reorientation state, may provide a quarter-wave retardance to the light 224 propagating therethrough, and provide a quarter-wave retardance to the light 226 propagating therethrough. Thus, the light 226 output from the FLC display panel 201 may be a linearly polarized light polarized in the 135° polarization direction within the x-y plane.

The switchable half-wave plate 207 that operates at the switching state may rotate the polarization direction of the light 226 by 45°, while transmitting the light 226 toward the polarization beam splitter 205. Thus, the switchable half-wave plate 207 may output a light 228 that may be a linearly polarized light polarized in the 90° polarization direction within the x-y plane. The polarization beam splitter 205 may substantially transmit the light 228 without affecting the propagation direction of the light 228. Accordingly, the FLC display assembly 200 may display a bright image (denoted by “Bright” in FIG. 2B). That is, the FLC display assembly 200 may also display the normal image (e.g., the bright image displayed in FIG. 2A) during the compensation sub-frame.

Referring to FIGS. 2A and 2B, in the present disclosure, the switchable half-wave plate 207 included in the FLC display assembly 200 may correct an inverse image (e.g., a black image), which would otherwise be displayed during the compensation sub-frame in existing technology, to be a normal image (e.g., a bright image). Thus, the backlight source 203, which would otherwise be turned off during the compensation sub-frame in existing technology, may be turned on during the compensation sub-frame in the present disclosure. That is, the backlight source 203 may be turned on during both of the normal sub-frame and the compensation sub-frame. As a result, the duty cycle of the backlight source 203 may be increased (e.g., doubled) and, accordingly, the power consumption of the backlight source 203 may be reduced. The power efficiency of the entire FLC display assembly 200 may be significantly increased.

In FIGS. 2A and 2B, the normal image is presumed to be a bright image displayed during the normal sub-frame, and the FLC display assembly 200 may also display the normal image (e.g., the bright image displayed in FIG. 2A) during the compensation sub-frame. Thus, the normal image may be displayed in both of the normal sub-frame and the compensation sub-frame. In some examples, the normal image may be presumed to be a dark image displayed during the normal sub-frame, and the FLC display assembly 200 may also be configured to display the normal image (e.g., the dark image) during the compensation sub-frame, following the operation principles shown in FIGS. 2A and 2B. That is, the controller 210 may control the switchable half-wave plate 207 to operate at the non-switching state and the FLC display panel 201 to operate during the normal sub-image frame, and control the switchable half-wave plate 207 to operate at the switching state and the FLC display panel 201 to operate during the compensation sub-image frame. The switching of the switchable half-wave plate 207 between the non-switching state and the switching state may be synchronized, by the controller 210, with the switching of the FLC display panel 201 between operating during the normal sub-frame and operating during the compensation sub-frame.

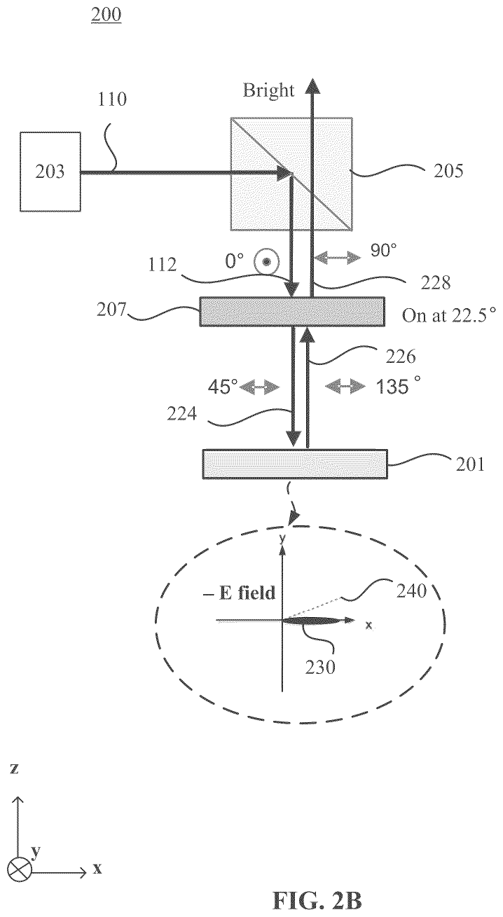

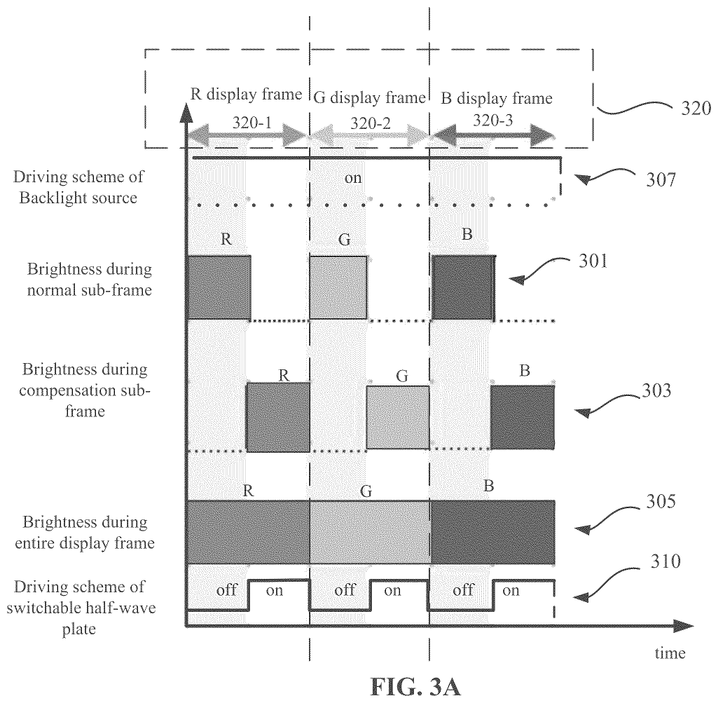

FIG. 3A illustrates a driving scheme of the FLC display assembly 200 for a single display frame 320, according to an example of the present disclosure. As shown in FIG. 3A, the single display frame 320 of the FLC display assembly 200 for displaying an image (e.g., a white image or a color image) may include a plurality of color display frames associated with different primary colors. The color display frames may be alternately arranged in the single display frame 320. For discussion purposes, FIG. 3A shows that the display frame 320 includes a display frame for a red (“R”) image (or a R display frame) 320-1, a display frame for a green (“G”) image (or a G display frame) 320-2, and a display frame for a blue (“B”) image (or a B display frame) 320-3 that are alternately arranged. The sequence of the R display frame 320-1, the G display frame 320-2, and the B display frame 320-3 included in the single display frame 320 shown in FIG. 3A is for illustrative purposes. In some examples, the R display frame 320-1, the G display frame 320-2, and the B display frame 320-3 may be arranged in other suitable sequences. Each of the color display frames 320-1, 320-2, and 320-3 may include a first sub-frame (e.g., a normal sub-frame) and a second sub-frame (e.g., a compensation sub-frame). For discussion purposes, the normal sub-frame and the compensation sub-frame of the color display frame 320-1, 320-2, or 320-3 may also be referred to as a color normal sub-frame and a color compensation sub-frame, respectively.

In FIG. 3A, a status plot 307 indicates a driving scheme of the backlight source 203. The controller 210 may configure the duty cycle of the backlight source (e.g., LED light sources) 203 for the respective color display frames 320-1, 320-2, and 320-3, e.g., via controlling the “on” time of the backlight source 203. The controller 210 may control the backlight source 203 to be turned on (denoted by “on” in FIG. 3A) for the same time duration in the first sub-frame (e.g., the normal sub-frame) and in the second sub-frame (e.g., the compensation sub-frame) of the respective color display frames 320-1, 320-2, and 320-3. In some examples, to display a white image, the backlight source 203 may be configured with the same duty cycle for the respective color display frames 320-1, 320-2, and 320-3. In some examples, to display a color image other than the white image, the backlight source 203 may be configured with different duty cycles for the respective color display frames 320-1, 320-2, and 320-3.

In FIG. 3A, a status plot 310 indicates a driving scheme of the switchable half-wave plate 207. The switching of the switchable half-wave plate 207 between the non-switching state and the switching state may be synchronized, by the controller 210, with the switching of the FLC display assembly 200 between the first sub-frames (e.g., the normal sub-frames) and the second sub-frames (e.g., the compensation sub-frames) of the respective color display frames 320-1, 320-2, and 320-3. The controller 210 may control the switchable half-wave plate 207 to operate at the non-switching state (denoted by “off” in the status plot 310 in FIG. 3A) during the first sub-frames (e.g., the normal sub-frames) of the respective color display frames 320-1, 320-2, and 320-3, and to operate at the switching state (denoted by “on” in the status plot 310 in FIG. 3A) during the second sub-frames (e.g., the compensation sub-frames) of the respective color display frames 320-1, 320-2, and 320-3. The switchable half-wave plate 207 may be configured with a fast switching speed, e.g., a speed equal to or greater than the switching speed of the FLC display assembly 200 between the first sub-frames (e.g., the normal sub-frames) and the second sub-frames (e.g., the compensation sub-frames) of the color display frame 320-1, 320-2, or 320-3.

In some examples, for the respective color display frames 320-1, 320-2, and 320-3, the controller 210 may control the switchable half-wave plate 207 to operate at the non-switching state during the entire first sub-frames (e.g., the normal sub-frames), and to operate at the switching state during the entire second sub-frames (e.g., the compensation sub-frames). In some examples, for the respective color display frames 320-1, 320-2, and 320-3, the controller 210 may control the switchable half-wave plate 207 to operate at the non-switching state during the entire first sub-frames (e.g., the normal sub-frames), and to operate at the switching state at least during the “on” time (or ON-time) of the backlight source 203 during the second sub-frames (e.g., the compensation sub-frames). For example, for the respective color display frames 320-1, 320-2, and 320-3, the controller 210 may control the switchable half-wave plate 207 to operate at the non-switching state during the entire first sub-frames (e.g., the normal sub-frames), to operate at the non-switching state during the “off” time (or OFF-time) of the backlight source 203 during the second sub-frames (e.g., the compensation sub-frames), to operate at the switching state during the “on” time of the backlight source 203 during the second sub-frames (e.g., the compensation sub-frames).

In FIG. 3A, as a brightness indicating plot 301 shows, during the normal sub-frames of the respective color display frames 320-1, 320-2, and 320-3, the FLC display assembly 200 may display normal images (e.g., bright images) of the respective primary colors, which together may form a predetermined normal image (e.g., predetermined bright image) with a predetermined image brightness. As a brightness indicating plot 303 shows, during the compensation sub-frames of the respective color display frames 320-1, 320-2, and 320-3, the FLC display assembly 200 may also display the normal images (e.g., bright images) of the respective primary colors, which together may form the same predetermined normal image (e.g., predetermined bright image) with the same predetermined image brightness. As a brightness indicating plot 305 shows, the image brightness during the entire display frame 320 may be a combination of the brightnesses shown in the brightness indicating plot 301 and brightnesses shown in the brightness indicating plot 303.

For discussion purposes, FIG. 3A shows a relationship between a display brightness and a driving scheme of the FLC display assembly 200 for displaying a white, 255-greyscale image. The controller 210 may control the duty cycle of the backlight source 203 to be about 100% for each color display frame 320-1, 320-2, or 320-3. That is, the controller 210 may control the backlight source 203 to be turned on (denoted by “on” in FIG. 3A) during the entire display frame 320. As the brightness indicating plot 301 shows, during the normal sub-frames of the color display frames 320-1, 320-2, and 320-3, the FLC display assembly 200 may display red, green, and blue normal images (e.g., bright images), respectively, which together may form a predetermined white, 255-greyscale image with a predetermined image brightness. As the brightness indicating plot 303 shows, during the compensation sub-frames of the color display frames 320-1, 320-2, and 320-3, the FLC display assembly 200 may also display the red, green, and blue normal images (e.g., bright images), respectively, which together may form the same white, 255-greyscale image with the same predetermined image brightness. Thus, during the entire display frame, a user may perceive a white, 255-greyscale image that is a combination of the normal white, 255-greyscale image displayed during the first sub-frames (e.g., the normal sub-frames) of the R, G, B display frames 320-1, 320-2 and 320-3, and the normal white, 255-greyscale image displayed during the second sub-frames (e.g., the compensation sub-frames) of the R, G, B display frames 320-1, 320-2 and 320-3.

Further, for discussion purposes, FIG. 3A shows that in the single display frame 320 of the FLC display assembly 200, each of the color display frame 320-1, 320-2, or 320-3 includes a single normal sub-frame and a single corresponding compensation sub-frame. In some examples, although not shown, at least one (e.g., each) of the color display frame 320-1, 320-2, or 320-3 may include a plurality of normal sub-frames and a plurality of corresponding compensation sub-frames. For example, at least one (e.g., each) of the color display frame 320-1, 320-2, or 320-3 may include two or more normal sub-frames before the image sticking occurs, and corresponding numbers of the compensation sub-frames for compensation purposes. The switchable half-wave plate 207 may operate at the non-switching state during the two or more normal sub-frames and operate at the switching state during the corresponding numbers of compensation sub-frames.

FIG. 3B illustrates a driving scheme of the FLC display assembly 200 for the single display frame 320, according to an example of the present disclosure. FIG. 3B shows a relationship between the display brightness and the driving scheme of the FLC display assembly 200 for displaying a white, 127-greyscale image. The controller 210 may configure the duty cycle of the backlight source 203 for displaying white images of different greyscales. The driving scheme of the FLC display assembly 200 for displaying the white, 127-greyscale image shown in FIG. 3B may be similar to the driving scheme of the FLC display assembly 200 for displaying the white, 255-greyscale image shown in FIG. 3A. In FIG. 3B, the controller 210 may control the duty cycle of the backlight source 203 to be about 30%. A status plot 357 indicates a driving scheme of the backlight source 203. The “on” time and “off”' time of the backlight source 203 are denoted by “on” and “off” in the status plot 357 in FIG. 3B, respectively. The status plot 310 indicates a driving scheme of the switchable half-wave plate 207.

In FIG. 3B, as a brightness indicating plot 351 shows, during the normal sub-frames of the color display frames 320-1, 320-2, and 320-3, the FLC display assembly 200 may display red, green, and blue normal images (e.g., bright images), respectively, which together may form a predetermined white, 127-greyscale image with a predetermined image brightness. As a brightness indicating plot 353 shows, during the compensation sub-frames of the color display frames 320-1, 320-2, and 320-3, the FLC display assembly 200 may also display the red, green, and blue normal images (e.g., bright images), respectively, which together may form the same white, 127-greyscale image with the same predetermined image brightness. As a brightness indicating plot 355 shows, the image brightness during the entire display frame 320 may be a combination of the brightnesses shown in the brightness indicating plot 351 and the brightnesses shown in the brightness indicating plot 353. Thus, during the entire display frame 320, a user may perceive a white, 127-greyscale image that is a combination of the normal white, 127-greyscale image displayed during the first sub-frames (e.g., the normal sub-frames) of the R, G, B display frames 320-1, 320-2 and 320-3, and the normal white, 127-greyscale image displayed during the second sub-frames (e.g., the compensation sub-frames) of the R, G, B display frames 320-1, 320-2 and 320-3.

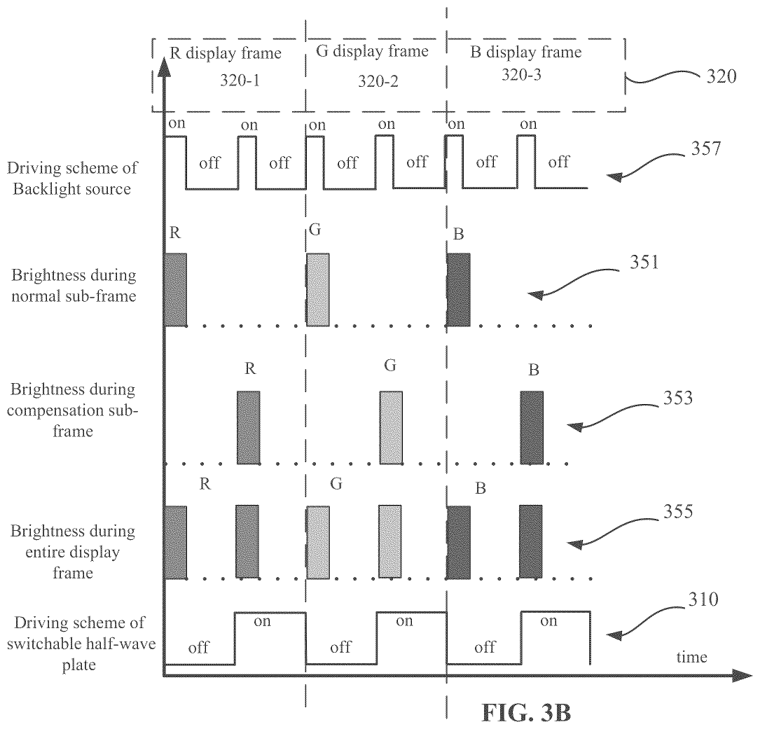

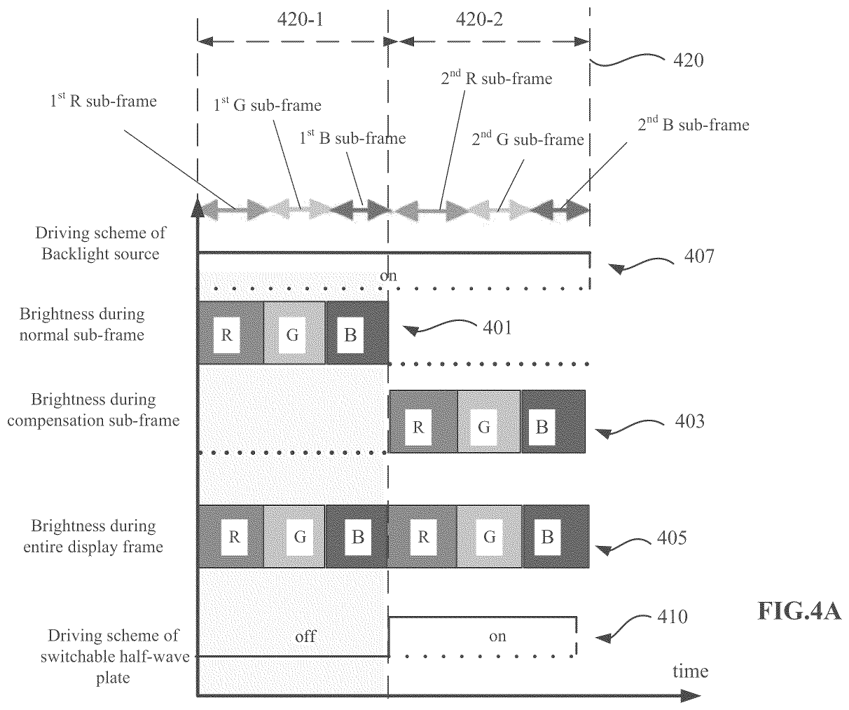

FIG. 4A illustrates a driving scheme of the FLC display assembly 200 for a single display frame 420, according to an example of the present disclosure. As shown in FIG. 4A, the single display frame 420 of the FLC display assembly 200 for displaying an image (e.g., a white image or a color image) may include a first sub-frame (e.g., a normal sub-frame) 420-1 and a second sub-frame (e.g., a compensation sub-frame) 420-2 that are alternately arranged. The single display frame 420 may also include a plurality of color display frames associated with different primary colors, and each color display frame may include a first sub-frame (e.g., a normal sub-frame) and a second sub-frame (e.g., a compensation sub-frame). The first sub-frame 420-1 may include the first sub-frames (e.g., the normal sub-frames) of the respective color display frames, and the second sub-frame 420-2 may include the corresponding second sub-frames (e.g., the compensation sub-frames) of the respective color display frames. During the first sub-frame 420-1, the respective first sub-frames (e.g., the normal sub-frames) of the color display frames may be alternately displayed. During the second sub-frame 420-2, the respective second sub-frames (e.g., the compensation sub-frames) of the color display frames may be alternately displayed.

For discussion purposes, FIG. 4A shows that the single display frame 420 includes an R display frame, a G display frame, and a B display frame. Accordingly, the first sub-frame (e.g., the normal sub-frame) 420-1 may include a first sub-frame (e.g., the normal sub-frame) of the R display frame (denoted as “1^{st} R sub-frame”), a first sub-frame (e.g., the normal sub-frame) of the G display frame (denoted as “1^{st} G sub-frame”), and a first sub-frame (e.g., the normal sub-frame) of the B display frame (denoted as “1^{st} B sub-frame”) that are alternately displayed. The second sub-frame (e.g., the compensation sub-frame) 420-2 may include a second sub-frame (e.g., the compensation sub-frame) of the R display frame (denoted as “2^{nd} R sub-frame”), a second sub-frame (e.g., the compensation sub-frame) of the G display frame (denoted as “2^{nd} G sub-frame”), and a second sub-frame (e.g., the compensation sub-frame) of the B display frame (denoted as “2^{nd} B sub-frame”) that are alternately displayed.

In FIG. 4A, a status plot 407 indicates a driving scheme of the backlight source 203. The controller 210 may configure the duty cycle of the backlight source (e.g., an LED light source) 203 for the respective color display frames, e.g., via controlling the “on” time of the backlight source 203. A status plot 410 indicates a driving scheme of the switchable half-wave plate 207. The controller 210 may control the switchable half-wave plate 207 to operate at the non-switching state (denoted by “off” in the status plot 410 in FIG. 4A) during the first sub-frame (e.g., the normal sub-frame) 420-1, and operate at the switching state (denoted by “on” in the status plot 410 in FIG. 4A) during the second sub-frame (e.g., the compensation sub-frame) 420-2. The switching of the switchable half-wave plate 207 between the non-switching state and the switching state may be synchronized, by the controller 210, with the switching of the FLC display assembly 200 between the first sub-frame (e.g., the normal sub-frame) 420-1 and the second sub-frame (e.g., the compensation sub-frame) 420-2. The driving scheme shown in FIG. 4A may reduce the burden on the switching speed of the switchable half-wave plate 207, enabling a wide range of selections for the switchable half-wave plate 207.

In some examples, the switchable half-wave plate 207 may operate at the non-switching state during the entire first sub-frame (e.g., the normal sub-frame) 420-1, and operate at the switching state during the entire second sub-frame (e.g., the compensation sub-frame) 420-2. In some examples, the switchable half-wave plate 207 may operate at the non-switching state during the entire first sub-frame (e.g., the normal sub-frame) 420-1, and operate at the switching state during at least the “on” time of the backlight source 203 during the second sub-frame (e.g., the compensation sub-frame) 420-2. For example, the switchable half-wave plate 207 may operate at the non-switching time during the “off” time of the of the backlight source 203 during the second sub-frame (e.g., the compensation sub-frame) 420-2.

In FIG. 4A, as a brightness indicating plot 401 shows, during the first sub-frame (e.g., the normal sub-frame) 420-1 of the display frame 420, the FLC display assembly 200 may display normal images (e.g., bright images) of the respective primary colors, which together may form a predetermined normal image (e.g., predetermined bright image) with a predetermined image brightness. As a brightness indicating plot 403 shows, during the second sub-frame (e.g., the compensation sub-frame) 420-2 of the display frame 420, the FLC display assembly 200 may also display the normal images (e.g., bright images) of the respective primary colors, which together may form the same predetermined normal image (e.g., predetermined bright image) with the same predetermined image brightness. As a brightness indicating plot 405 shows, the image brightness during the entire display frame 420 may be a combination of the brightnesses shown in the brightness indicating plot 401 and the brightnesses shown in the brightness indicating plot 403.

For discussion purposes, FIG. 4A shows a relationship between the display brightness and the driving scheme of the FLC display assembly 200 for displaying a white, 255-greyscale image. The controller 210 may control the duty cycle of the backlight source 203 to be about 100% for each color display frame included in the display frame 420. That is, the controller 210 may control the backlight source 203 to be turned on (denoted by “on” in the status plot 407 in FIG. 4A) during the entire display frame 420. As the brightness indicating plot 401 shows, during the first sub-frame (e.g., the normal sub-frame) 420-1, the FLC display assembly 200 may display red, green, and blue normal images (e.g., bright images), respectively, which together may form a predetermined white, 255-greyscale image with a predetermined image brightness. As the brightness indicating plot 403 shows, during the second sub-frame (e.g., the compensation sub-frame) 420-2, the FLC display assembly 200 may also display the red, green, and blue normal images (e.g., bright images), respectively, which together may form the same white, 255-greyscale image with the same predetermined image brightness. Thus, during the entire display frame 420, a user may perceive a white, 255-greyscale image that is a combination of the white, normal 255-greyscale image displayed during the first sub-frame (e.g., the normal sub-frame) 420-1 and the white, normal 255-greyscale image displayed during the second sub-frame (e.g., the compensation sub-frame) 420-2.

Further, for discussion purposes, FIG. 4A shows that the single display frame 420 of the FLC display assembly 200 includes a single normal sub-frame 420-1 and a single compensation sub-subframe 420-2. In some examples, although not shown, the single display frame 420 of the FLC display assembly 200 may include a plurality of normal sub-frames and a plurality of corresponding compensation sub-subframes. For example, the single display frame 420 may include two or more normal sub-frames before the image sticking occurs, and corresponding numbers of the compensation sub-frames for compensation purposes. The switchable half-wave plate 207 may operate at the non-switching state during the two or more normal sub-frames and operate at the switching state during the corresponding numbers of the compensation sub-frames.

FIG. 4B illustrates a driving scheme of the FLC display assembly 200 for the single display frame 420, according to an example of the present disclosure. FIG. 4B shows a relationship between the display brightness and the driving scheme of the FLC display assembly 200 for displaying a white, 127-greyscale image. The driving scheme of the FLC display assembly 200 for displaying the white, 127-greysacle image shown in FIG. 4B may be similar to the driving scheme of the FLC display assembly 200 for displaying the white, 255-greyscale image shown in FIG. 4A. In FIG. 4B, the controller 210 may control the duty cycle of the backlight source 203 to be about 30%. A status plot 457 indicates a driving scheme of the backlight source 203. The “on” time and “off” time of the backlight source 203 are denoted by “on” and “off” in the status plot 457 in FIG. 4B, respectively. The status plot 410 indicates a driving scheme of the switchable half-wave plate 207.

In FIG. 4B, as a brightness indicating plot 451 shows, during the first sub-frame (e.g., the normal sub-frame) 420-1, the FLC display assembly 200 may display red, green, and blue normal images (e.g., bright images), respectively, which together may form a predetermined white, 127-greyscale image with a predetermined image brightness. As a brightness indicating plot 453 shows, during the second sub-frame (e.g., the compensation sub-frame) 420-2, the FLC display assembly 200 may also display the red, green, and blue normal images (e.g., bright images), respectively, which together may form the same white, 127-greyscale image with the same predetermined image brightness. As a brightness indicating plot 455 shows, the image brightness during the entire display frame 420 may be a combination of the brightnesses shown in the brightness indicating plot 451 and the brightnesses shown in the brightness indicating plot 453. Thus, during the entire display frame 420, a user may perceive a white, 127-greyscale image that is a combination of the normal white, 127-greyscale image displayed during the first sub-frames (e.g., the normal sub-frames) 420-1, and the normal white, 127-greyscale image displayed during the second sub-frames (e.g., the compensation sub-frames) 420-2.

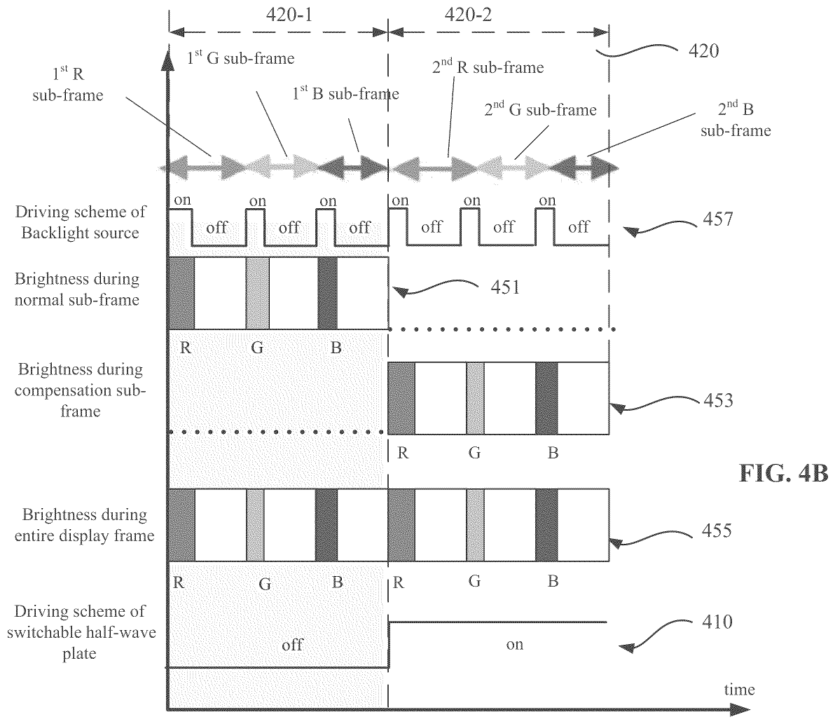

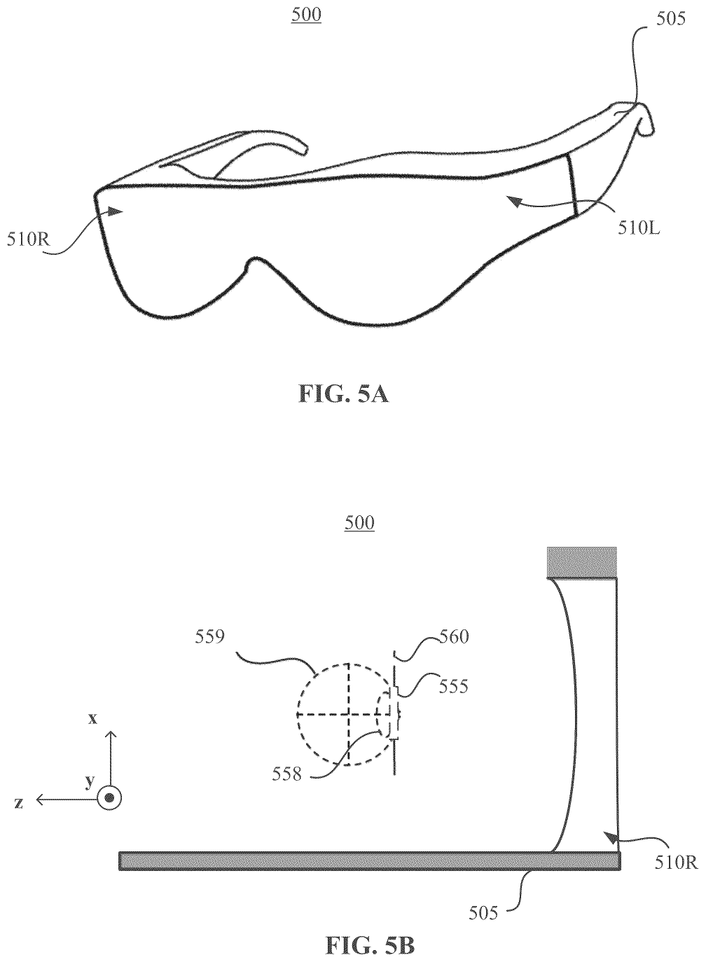

FIG. 5A illustrates a schematic diagram of an artificial reality system 500, according to an example of the present disclosure. The artificial reality system 500 may present VR, AR, and/or MR content to a user, such as images, video, audio, or a combination thereof. In some examples, the artificial reality system 500 may be configured to be worn on a head of a user (e.g., by having the form of spectacles or eyeglasses, as shown in FIG. 5A), or to be included as part of a helmet that is worn by the user. In some examples, the artificial reality system 500 may be referred to as a head-mounted display. In some examples, the artificial reality system 500 may be configured for placement in proximity of an eye or eyes of the user at a fixed location in front of the eye(s), without being mounted to the head of the user. For example, the artificial reality system 500 may be mounted in a vehicle, such as a car or an airplane, at a location in front of an eye or eyes of the user.

For discussion purposes, FIG. 5A shows that the artificial reality system 500 includes a frame 505 configured to mount to a head of a user, and left-eye and right-eye display systems 510L and 510R mounted to the frame 505. The frame 505 is merely an example structure to which various components of the artificial reality system 500 may be mounted. Other suitable type of fixtures may be used in place of or in combination with the frame 505. The left-eye and right-eye display systems 510L and 510R may be customized with any suitable shapes and/or sizes to conform to the structures of the frame 505.

FIG. 5B is a cross-sectional view of half of the artificial reality system 500 shown in FIG. 5A according to an example of the present disclosure. For illustrative purposes, FIG. 5B shows the cross-sectional view associated with the right-eye display system 510R. Referring to FIGS. 5A and 5B, each of the left-eye display system 510L and the right-eye display system 510R may include a display device (e.g., a projector) configured to project a virtual image through an eye-box region 560 of the artificial reality system 500. In some examples, the projector may be configured to incorporate dynamic zonal brightness control, enhancing the display performance and power budget. Such a projector may be referred to as a zonal illuminated projector. In some examples, each of the left-eye display system 510L and the right-eye display system 510R may include an FLC display assembly disclosed herein, such as the FLC display assembly 200 shown in FIG. 1, and FIGS. 2A and 2B, which may be controlled to operate according to FIGS. 3A-4B. The eye-box region 560 is a region in space where an eye 559 of the user is positioned to perceive the virtual image projected by the zonal illuminated projector. The eye-box region 560 may include one or more exit pupils 557. The zonal illuminated projector may project the virtual image through the one or more exit pupils 557, and an eye pupil 558 may be positioned at the one or more exit pupils 557 to perceive the virtual image projected by the zonal illuminated projector.

Any of the steps, operations, or processes described herein may be performed or implemented with one or more hardware and/or software modules, alone or in combination with other devices. A software module may be implemented with a computer program product including a computer-readable medium containing computer program code, which can be executed by a computer processor for performing any or all of the steps, operations, or processes described. In some examples, a hardware module may include hardware components such as a device, a system, an optical element, a controller, an electrical circuit, a logic gate, etc.

Embodiments of the disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or perform computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A display assembly, comprising:
a polarizing optical component configured to reflect a light having a first polarization and transmit a light having a second polarization orthogonal to the first polarization;
a ferroelectric liquid crystal (“FLC”) display panel configured with a display frame that includes a normal sub-frame and a compensation sub-frame;
a polarization switch disposed between the FLC display panel and the polarizing optical component; and
a controller configured to control the polarization switch to operate at a non-switching state during the normal sub-frame and operate at a switching state during the compensation sub-frame.

2. The display assembly of claim 1, wherein the polarizing optical component includes a polarization beam splitter or a reflective polarizer.

3. The display assembly of claim 1, wherein the polarization switch includes a switchable half-wave plate.

4. The display assembly of claim 1, wherein the FLC display panel includes a reflective FLC display panel.

5. The display assembly of claim 1, wherein the controller is configured to in-plane switch FLC molecules in the FLC display panel to a first side of an alignment direction of the FLC molecules during the normal sub-frame, and in-plane switch the FLC molecules to a second, opposing side of the alignment direction during the compensation sub-frame.

6. The display assembly of claim 1, further comprising a backlight source configured to emit a backlight propagating toward the polarizing optical component.

7. The display assembly of claim 6, wherein the controller is configured to control the backlight source to emit the backlight during both of the normal sub-frame and the compensation sub-frame.

8. The display assembly of claim 6, wherein during both of the normal sub-frame and the compensation sub-frame of the display frame:
the polarizing optical component is configured to reflect the backlight toward the polarization switch and the FLC display panel;
the FLC display panel is configured to modulate the backlight into an image light propagating toward the polarization switch and the polarizing optical component; and
the polarization switch and the polarizing optical component are configured to transmit the image light.

9. The display assembly of claim 6, wherein during the normal sub-frame of the display frame:
the polarizing optical component is configured to reflect the backlight toward the polarization switch as a first light having the first polarization;
the polarization switch is configured to transmit the first light toward the FLC display panel as a second light having the first polarization;
the FLC display panel is configured to reflect the second light having the first polarization back to the polarization switch as a third light having the second polarization;
the polarization switch is also configured to transmit the third light toward the polarizing optical component as a fourth light having the second polarization; and
the polarizing optical component is also configured to transmit the fourth light having the second polarization.

10. The display assembly of claim 9, wherein during the compensation sub-frame of the display frame:
the polarizing optical component is configured to reflect the backlight toward the polarization switch as the first light having the first polarization;
the polarization switch is configured to transmit the first light having the first polarization toward the FLC display panel as a fifth light having a third polarization;
the FLC display panel is configured to reflect the fifth light having the third polarization back to the polarization switch as a sixth light having a fourth polarization orthogonal to the third polarization;
the polarization switch is configured to transmit the sixth light having the fourth polarization toward the polarizing optical component as a seventh light having the second polarization; and
the polarizing optical component is configured to transmit the seventh light having the second polarization.

11. The display assembly of claim 1, wherein
the display frame includes a plurality of color display frames that are alternately arranged; and
a color display frame of the plurality of color display frames includes the normal sub-frame and the compensation sub-frame.

12. The display assembly of claim 11, wherein
the normal sub-frame of the color display frame includes a first normal sub-frame and a second normal sub-frame that are alternately arranged; and
the compensation sub-frame of the color display frame includes a first compensation sub-frame and a second compensation sub-frame that are alternately arranged.

13. The display assembly of claim 1, wherein
the normal sub-frame and the compensation sub-frame of the display frame are alternately arranged;
the display frame includes a plurality of color display frames;
each color display frame includes a color normal sub-frame and a color compensation sub-frame;
the normal sub-frame of the display frame includes a plurality of color normal sub-frames of the color display frames; and
the compensation sub-frame of the display frame includes a plurality of color compensation sub-frames of the color display frames.

14. The display assembly of claim 1, wherein the controller is configured to synchronize a switching of the polarization switch between the non-switching state and the switching state with a switching of the FLC display panel between the normal sub-frame and the compensation sub-frame of the display frame.

15. The display assembly of claim 1, wherein
the normal sub-frame of the display frame includes a first normal sub-frame and a second normal sub-frame that are alternately arranged; and
the compensation sub-frame of the display frame includes a first compensation sub-frame and a second compensation sub-frame that are alternately arranged.
